(19) United States
(12) Patent Application Publication
(10) Pub. No.: US 2022/0021192 A1
(43) Pub. Date: Jan. 20, 2022

(54) SMOOTH-CORNERED WELDED BOX

(71) Applicant: ABB Schweiz AG, Baden (CH)

(72) Inventors: Jonah Kadoko, Mint Hill, NC (US); Phillip Taylor, Germantown, TN (US); Charles C. Britton, Germantown, TN (US)

(21) Appl. No.: 16/930,856

(22) Filed: Jul. 16, 2020

(51) Int. Cl. H02G 3/08; B21D 51/52

(52) U.S. Cl. CPC H02G 3/085; B21D 51/52

(57) ABSTRACT

An electrical box comprising a perimeter wall having a plurality of sidewalls and a base wall. Each sidewall of the plurality of sidewalls can be generally orthogonal, and directly adjoined by a rounded touch-safe corner, to another sidewall of the plurality of sidewalls. Additionally, a first end of the perimeter wall can be mechanically interlocked to, and coplanar with, a second end of the perimeter wall so as to provide the perimeter wall with a generally seamless sleeve configuration. The base wall, which may be separate from the perimeter wall, or adjoined to the perimeter wall in a monolithic structure, can be adjoined to at least some portions of the perimeter wall. Further, the base wall and the perimeter wall can define an inner region of the electrical box.

### FIELD OF INVENTION

The present invention relates to electrical boxes for surface and in-wall mounting, and more particularly, relatively smooth-cornered welded metal electrical boxes.

### BACKGROUND

Electrical boxes can be used for a variety of applications, including, for example, in connection with the mounting and/or housing of electrical devices, such as, for example, outlets switches, and ceiling fixtures, as well as be used as junction boxes. Further, such boxes can be mounted in a variety of manners, including, but not limited to, on or outside of a wall, also referred to as surface mount, or at a recessed location, including in-wall mounting.

Traditional methods of manufacturing metallic electrical boxes can result in electrical boxes that have relatively sharp corners or edges. However, such relatively sharp corners or edges can create cut hazards, particularly when the box is surface mounted. Such cut hazards can be particularly hazardous at least for the installer of the box, among others who may come into contact with the electrical box.

Attempts to address such hazards have included manufacturing drawn boxes. For example, at least some electrical boxes are formed by deep drawing a flat sheet of metallic material, and subsequently trimming off excess material from the formed edges of the box. Yet, the manufacturing expenses associate with drawn boxes can be relatively high. Further, the processes associated with manufacturing drawn boxes can present limitations as to the box depth that may be attained for the electrical box.

Accordingly, although various electrical boxes are available currently in the marketplace, further improvements are possible to provide a means for providing relatively low-cost electrical boxes having smooth corners, and which can have relatively large box depths.

### BRIEF SUMMARY

An aspect of an embodiment of the present application is an electrical box comprising a perimeter wall having a plurality of sidewalls and a base wall. Each sidewall can be orthogonal to an adjacent sidewall. Additionally, adjacent sidewalls of the plurality of sidewalls can be directly adjoined by a rounded corner. Further, a first end of the perimeter wall can be mechanically interlocked with a second end of the perimeter wall such that the first and second ends are coplanar. Additionally, the base wall can be adjoined to the perimeter wall, and the base wall and the perimeter wall can define an inner region of the electrical box.

Another aspect of an embodiment of the present application is an electrical box comprising a plurality of sidewalls and a base wall. One or more sidewalls of the plurality of sidewalls can be directly adjoined to an adjacent, and orthogonally directed, sidewall of the plurality of sidewalls by a rounded corner. Further, at least one sidewall of the plurality of sidewalls can comprise a first wall segment and a second wall segment, the first wall segment having one or more first joint segments that are at least mechanically interlocked with one or more second joint segments of the second wall segment such that the first wall segment is coplanar with the second wall segment. Additionally, the base wall can be adjoined to the plurality of sidewalls. Further, the plurality of sidewalls and the base wall can define an inner region of the electrical box.

Additionally, an aspect of the present application is a method for forming an electrical box that can include bending a pre-formed perimeter wall along a plurality of boundary lines to form a plurality of sidewalls, at least one sidewall being orthogonal, and directly adjoined by a rounded corner, to another sidewall. A first wall segment of a first sidewall of the plurality of sidewalls can be mechanically interlocked with a second wall segment of the first sidewall, the mechanically interlocked first and second wall segments being coplanar, and wherein the mechanically interlocked first and second wall segments and the plurality of sidewalls form a perimeter wall having a sleeve configuration. Further, a base wall can be secured to one or more of the plurality of sidewalls, the secured base wall and the perimeter wall defining a inner region of the electrical box.

These and other aspects of the present invention will be better understood in view of the drawings and following detailed description.

### BRIEF DESCRIPTION OF THE DRAWINGS

The description herein makes reference to the accompanying figures wherein like reference numerals refer to like parts throughout the several views.

FIG. 1 illustrates a side perspective view of an electrical box according to an embodiment of the present application.

FIG. 2 illustrates a side view of a bendable, and unitary, pre-formed perimeter wall for the electrical box shown in FIG. 1.

FIG. 3 illustrates a top side view of a back wall, or second portion, for the electrical box shown in FIG. 1.

FIG. 4 illustrates an exploded view of an unassembled electrical box in which the pre-formed perimeter wall shown in FIG. 2 is in a partially bent configuration and prior to the ends of the perimeter wall being mechanically interlocked.

FIG. 5 illustrates an exploded view of an electrical box shown in FIG. 1.

FIG. 6 illustrates a first side view of the electrical box shown in FIG. 1.

FIG. 7 illustrates a magnified view of the area designated “A” in FIG. 6, and shows an exemplary mechanical interlocking of a portion of the ends of the perimeter wall.

FIG. 8 illustrates a unitary pre-formed electrical box having a mechanically connectable perimeter wall adjoined to a back wall according to another embodiment of the present application

FIG. 9 illustrates an exemplary pattern in connection with producing a plurality of the pre-formed electrical boxes shown in FIG. 8 from a single sheet of material.

FIG. 10 illustrates a unitary pre-formed electrical box having a mechanically connectable perimeter wall adjoined to a back wall according to another embodiment of the present application.

FIG. 11 illustrates an exemplary pattern in connection with producing a plurality of the pre-formed electrical boxes shown in FIG. 10 from a single sheet of material.

The foregoing summary, as well as the following detailed description of certain embodiments of the present application, will be better understood when read in conjunction with the appended drawings. For the purpose of illustrating the application, there is shown in the drawings, certain embodiments. It should be understood, however, that the present application is not limited to the arrangements and instrumentalities shown in the attached drawings. Further, like numbers in the respective figures indicate like or comparable parts.

### DESCRIPTION OF THE ILLUSTRATED EMBODIMENTS

Certain terminology is used in the foregoing description for convenience and is not intended to be limiting. Words such as “upper,” “lower,” “top,” “bottom,” “first,” and “second” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

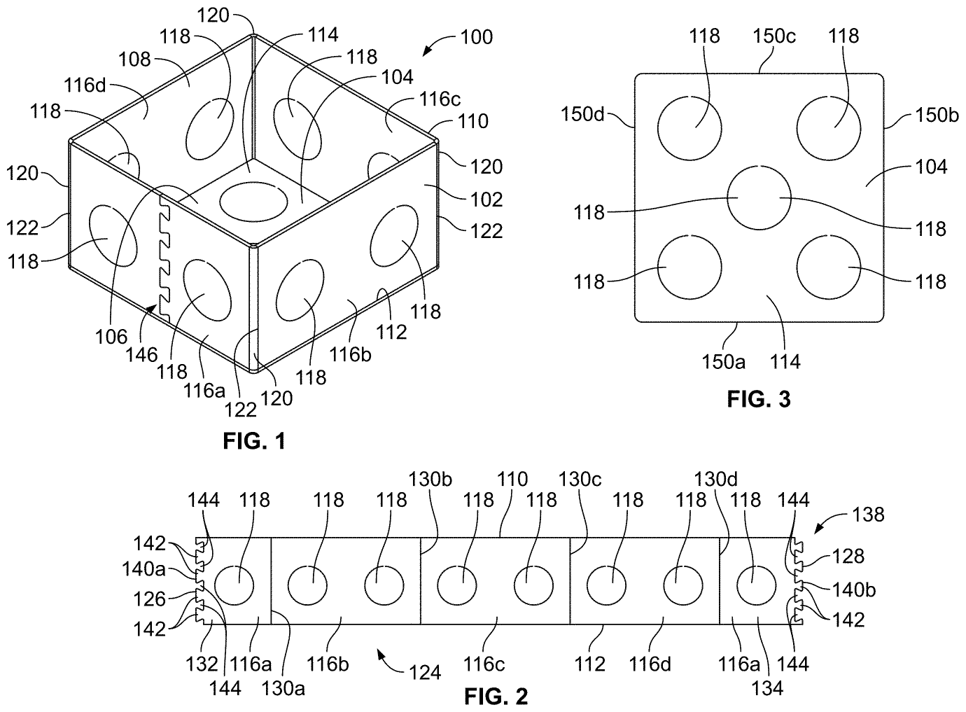

FIG. 1 illustrates a side perspective view of an electrical box 100 according to an embodiment of the present application. The electrical box 100 can comprise a perimeter wall 102 and a back wall 104. The perimeter wall 102 and the back wall 104 can be constructed from a variety of different materials, including, for example, metallic materials. For example, according to certain embodiments, the perimeter wall 102 and back wall 104 can be constructed from a 1/16 inch (1.5 mm) thick sheet or roll of metal.

The perimeter wall 102 and back wall 104 can generally define an inner region 106 of the electrical box 100. According to the illustrated embodiment, the electrical box 100 can have an open end 108 that opposes the back wall 104 that is in fluid communication with the inner region 106. The open end 108 can, when the electrical box 100 is installed in an associated application, be at least partially covered, such as, for example, by an electrical device, cover, fixture, or wall, as well as a combination thereof. Thus, according to certain embodiments, the perimeter wall 102 can include flanges and associated orifices that can receive mechanical fasteners, such as, for example, screws that can assist in mounting the electrical bod 100 to a fixtures, cover, or electrical device. Further, the electrical box 100 can have a box depth within the inner region 106 that extends between upper and lower edges 110, 112 of the perimeter wall 102, and/or between an upper edge 110 of the perimeter wall 102 and an inner surface 114 of the back wall 104. The back wall 104 can include locations, such as, for example, one or more apertures, for receipt of mechanical fasteners, such as, for example, screws, that can be utilized in securing the electrical box 100 at a location, such as, for example to a wall and/or stud. Such apertures can also be utilized in connecting a ground wire to the electrical box 100.

As shown in at least FIG. 1, one or more of the sidewalls 116a-d, and/or the back wall 104, can include one or more removable knockouts 118. According to certain embodiments, the knockouts 118 can be partially stamped portions of the sidewalls 116a-d or back wall 104 that can be selectively removable to provide a knockout opening. Such a knockout opening(s) can extend through the associated sidewall 116a-d or back wall 104, and be in fluid communication with the inner region 106 of the electrical box 100. Thus for example, removal of a knockout 118 can provide an opening in the sidewall 116a-d or back wall 104 that allows for the passage of cables, wire, or conduit, among other components, through the associated sidewall 116a-d and into the inner region 106 of the electrical box 100.

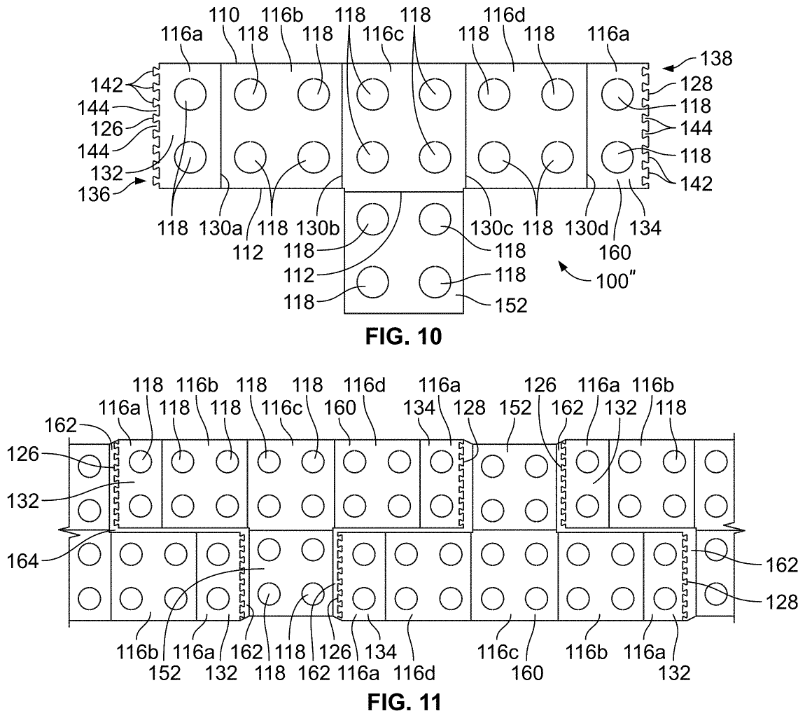

The number and size of knockouts 118, if any, can vary for each sidewall 116a-d, back wall 104, and/or electrical box 100. According to the embodiment shown in FIG. 1, the electrical box 100 has a box depth, and a width across each sidewall 116a-d between two adjacent rounded corners 120 of the electrical box 100 that can accommodate each sidewall 116a-d having two knockouts 118, and the back wall 104 having four knockouts 118. However, according to other embodiments, the electrical box 100 can have a box depth that can, for example, accommodate each sidewall 116a-d having four knockouts 118, as indicated by at least FIGS. 10 and 11.

In the illustrated embodiment, the exemplary perimeter wall 102 is depicted as providing four sidewalls 116a-d that form a generally square or rectangular shape. Accordingly, to such an embodiment, each sidewall 116a-d can be generally orthogonal, and directly connected to, an adjacent sidewall 116a-d. However the perimeter wall 102 can have a variety of other shapes, sizes, and configurations. For example, the perimeter wall 102 can have a generally circular, oval, or non-circular shape, including, but not limited to, polygonal shapes. Additionally, according to certain embodiments, the perimeter wall 102 can, for example, have a height between the upper and lower edges 110, 112 of the perimeter wall 102 of about 2.5 inches or about 4 inches, among other sizes. Further, according to certain embodiments, each sidewall 116a-d can have a length between opposing ends 122 the sidewall 116a-d of about 4 inches, among other lengths.

FIG. 2 illustrates a side view of an exemplary pre-formed perimeter wall 124 prior to being bent or folded, and interlocked, into a sleeve configuration that will provide the square or rectangular shaped perimeter wall 102 for the electrical box 100 that is shown in FIG. 1. Moreover, FIG. 2 illustrates the configuration of the pre-formed perimeter wall 124 after being cut, stamped, or otherwise formed by another process from a sheet or roll of metal, among other materials. As seen, the pre-formed perimeter wall 124 extends between first and second ends 126, 128 of the pre-formed perimeter wall 124, and includes the opposing upper and lower edges 110, 112 of the perimeter wall 102. For at least purposes of reference, FIG. 2 also depicts boundary lines 130a-d at which the pre-formed perimeter wall 124 will be bent so as to change the direction at which the perimeter wall 102 extends, and thus provide the sidewalls 116a-d of the perimeter wall 102. Additionally, for at least purposes of reference, the portions of the pre-formed perimeter wall 124 that will, after the pre-formed perimeter wall 124 is bent, provide each of the sidewalls 116a-d of the depicted perimeter wall 102 are also indicated in FIG. 2.

As seen, according to the illustrated embodiment, three of the sidewalls 116b-d have a unitary or uninterrupted configuration in that the sidewalls 116b-d are generally continuous and not completely separated from other portions of the associated sidewall 116b-d. However, as seen, one sidewall 116a is not unitary or uninterrupted, and instead is separated between detached first and second wall segments 132, 134. As seen, the first wall segment 132 of the sidewall 116a extends between a first boundary line 130a to the first end 126 of the pre-formed perimeter wall 124, the first boundary line 130a being the boundary line 130a-d that is in closest proximity to the first end 126 of the unfolded pre-formed perimeter wall 124. The second wall segment 134 of the sidewall 116a extends between a second boundary line 130d to the second end 128 of the pre-formed perimeter wall 124, the second boundary line 130d being the boundary line 130a-d that is in closest proximity to the second end 128 of the unfolded pre-formed perimeter wall 124. However, according to other embodiments, rather than having a separation that will be located between boundary lines 130a, 130d for a single sidewall 116a, the pre-formed perimeter wall 124 can be configured such that, when bent into the shape of the perimeter wall 102, the first and second ends 126, 128 are positioned at a boundary line 130a-d or corner 120 of the perimeter wall 102. Thus, according to such an embodiment, each sidewall 116a-d can have a generally unitary or uninterrupted configuration between associated boundary lines 130a-d.

According to the illustrated embodiment, the first end 126 of the pre-formed perimeter wall 124 can include one joint segments 136 that can matingly engage, and mechanically interlock with, one or more corresponding joint segments 138 at the second end 128 of the pre-formed perimeter wall 124. According to certain embodiments, the joint segment 136 at the first end 126 of the pre-formed perimeter wall 124 can comprise a male or female joint segment, and the mating joint segment 138 at the second end 128 can comprise the other of the male or female joint segment. Alternatively, the joint segments 136, 138 can each comprise a combination of interlocking male and female joint segments. According to the illustrated embodiment, the joint segments 136, 138 can extend along at least a portion of a side edge 140a-b at the first and second ends 126, 128, respectively, between the upper and lower edges 110, 112 of the pre-formed perimeter wall 124. Further, the joint segments 136, 138 can be formed or cut in a variety of manners, including, for example, formed via a stamping operation.

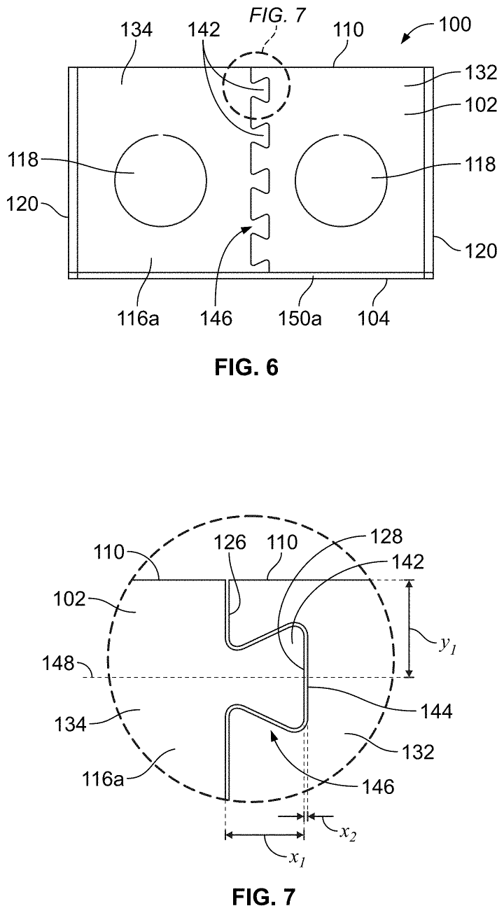

The form of the joint segments 136, 138 can vary for different types interlocking engagements. For example, as seen in at least FIGS. 2, 6, and 7, according to the illustrated embodiment, the joint segments 136, 138 each comprise male joint segments in the form of a plurality of outwardly projecting tails or pins 142, and female joint segments in the form of one or more mating grooves 144. Such pins 142 and grooves 144 can have generally trapezoidal configurations that can, when matingly engage with each other, provide a dovetail joint 146. According to such an embodiment, when the joint segments 136, 138 are matingly engaged or interlocked, such a dovetail joint 146 can provide at least resistance to pins 142 being pulled out of the mating grooves 144 through an opening of the groove 144 that extends through the associated side edge 140a, 140b of the pre-formed perimeter wall 124.

As seen in FIG. 7, according to an exemplary embodiment, the pins 142 can have a length (as generally indicated by “x₁”) of about one-quarter inch, and more specifically, about 0.20 inches. Further, the groove 144 can have a depth that is generally similar to the length of the mating pin 142. Moreover, while certain portions of the pins 142 and mating grooves 144 can have similar sizes so as to accommodate at least a partial interference, press, or snap fit between the pins 142 and the mating grooves 144, other portions of the groove 144 can be sized to provide a degree of clearance for the pins 142. For example, as seen in FIG. 7, the groove 144 can have an excess depth or clearance (as generally indicated by “x₂” in FIG. 7) that exceeds the length of the pin 142, so as to provide a degree of clearance for insertion of the pin 142 into the groove 144. While the extent of the clearance, if any, can vary, according to the illustrated embodiment, the clearance can be around half a tenth of an inch. Further, according to the illustrated embodiment, the first pin 142 and mating first groove 144 can be positioned about a centerline 148 that is about a quarter of an inch below the adjacent upper edge 110 of the perimeter wall 102 (as generally indicated by “y₁” in FIG. 7).

FIG. 3 illustrates a top side view of a back wall 104 for the electrical box 100 shown in FIG. 1. According to certain embodiments, the bottom side of the back wall 104 may also have the same appearance as that shown in FIG. 3. The back wall 104 can be configured to have a shape and size that generally corresponds to the shape and size of the perimeter wall 102 of the electrical box 100. Thus, similar to the perimeter wall 102, the back wall 104 can have a circular, oval, or non-circular shape, including, for example, a rectangular or square shape, as shown in FIG. 3. Accordingly, in the illustrated embodiment, the back wall 104 can have a plurality of edges 150a-d that are sized and positioned to correspond to the shape and size of the perimeter wall 102. Moreover, each edge 150a-d of the back wall 104 can be positioned to be adjacent to an opposing lower edge 112a-d of the perimeter wall 102 such that when the electrical box 100 is assembled, the edges 150a-d of the back wall 104 are generally flush with the adjacent outer or exterior surfaces of the perimeter wall 102. Thus, for example, in the illustrated embodiment in which each sidewall 116a-d of the perimeter 102 is about four inches in length, each edge 150a-d can also have a similar length of about four inches, among other lengths. Further, as seen in FIG. 3, similar to the sidewalls 116a-d, the back wall 104 can also include a plurality of knockouts 118.

Referencing FIGS. 2 and 3, during assembly of the electrical box 100, the pre-formed perimeter wall 124 can be bent to form the desired shape or configuration of the perimeter wall 102 of the electrical box 100. According to certain embodiments, such bending, which can include, for example, roll-forming, of the pre-formed perimeter wall 124, can occur at or around the boundary lines 130a-d that are shown in FIG. 2. Further, the resulting corners 120 of the perimeter wall 102, and thus of the electrical box 100, formed by such bending, and which provide for changes in direction in the perimeter wall 102, can have relatively smooth curved or round touch-safe shape. Moreover, the rounded transition that the corners 120a-d provide between the sidewalls 116a-d can eliminate relatively sharp corners, and associated cut hazards, that can be created by the traditional unions, such as, for example, abutting, of separate and individual metal sidewalls.

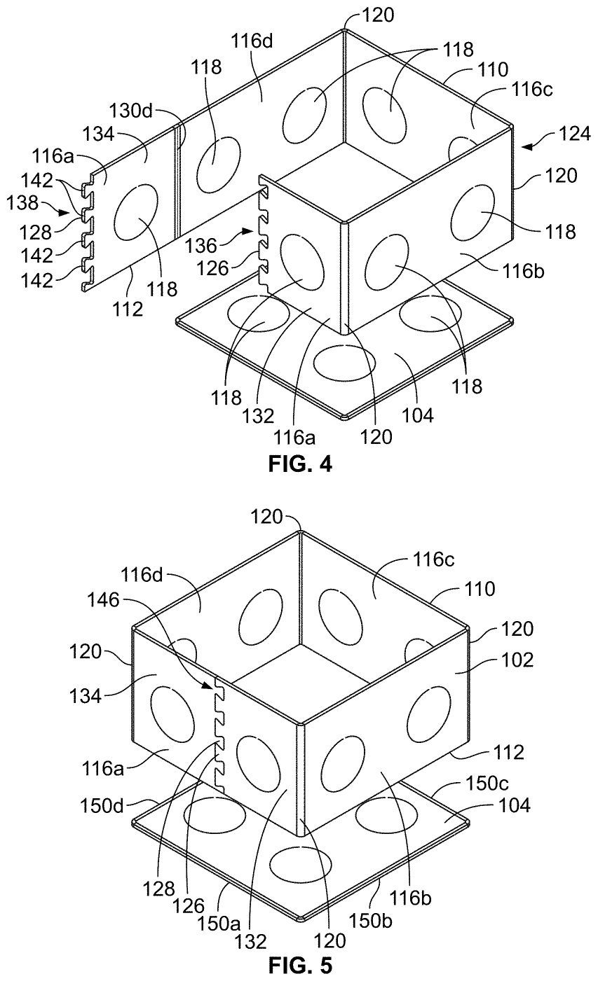

According to certain embodiments, the bending of the pre-formed perimeter wall 124 can be performed in an order that results in the first or second boundary line 130a, 130d that is adjacent to the first or second wall segment 132, 134 being the last portion of the pre-formed perimeter wall 124 to undergo a bending operation, as shown in FIG. 4. Such bending at the first or second boundary line 130a, 130d can result in the corresponding joint segment(s) 136, 138 adjacent to the first or second wall segment 132, 134 being inserted, pressed, and/or forced into the mating joint segment(s) 136, 138 of the other wall segment 136, 138 in a manner that interlocks the mating joint segments 136, 138. Such interlocking engagement between the mating joint segments 136, 138, as well as the bending of the pre-formed perimeter wall 124, can result in the formed perimeter wall 102 having a generally seamless sleeve configuration, as shown in FIG. 5. Moreover, the joint 146 formed between, and joining the first and second wall segments 132, 134 can be configured to prevent the first wall segment 136 from outwardly or inwardly protruding relative to the second wall segment 138, and vice versa. Moreover, the first and second wall segments 132, 134 and associated joint segments 136, 138 can be coplanar. Thus, according to certain embodiments, the first and second wall segments 132, 134 and associated joint segments 136, 138 can form a generally continuous plane or unbroken surface.

With the perimeter wall 102 formed in a generally seamless sleeve configuration, the perimeter wall 102 can be adjoined to the back wall 104. Such adjoining of the perimeter wall 102 to the back wall 104 can be attained in a variety of different manners. For example, according to certain embodiments, the perimeter wall 102 can be spot welded to the back wall 104. Such spot welding can occur at a variety of locations, such as, for example, in the vicinity of the lower edge 112 of the perimeter wall 102 and one or more edges 150a-d of the back wall 104. Further, as the perimeter wall 102 is formed in the generally seamless sleeve configuration, the perimeter wall 102 can be welded in relatively few spots. For example, according to certain embodiments, two spots weld, each along a different sidewall 116a-d, can be utilized to adjoin the perimeter wall 102 to the back wall 104. Alternatively, according to other embodiments, a single spot weld can be placed at along each of the sidewalls 116a-d and an adjacent portion or edge 150a-d of the back wall 104. Thus, referencing the electrical box shown in FIG. 1, according to certain embodiments, the perimeter wall 102 can be adjoined to the back wall 104 via four spot welds. Such a configuration however does not preclude the use of additional spot welds, including, for example, the placement of two spot welds along each of the sidewalls 116a-d. Additionally, or optionally, according to certain embodiments, one or more spot welds can also be utilized along a portion of the interlocking connection between the joint segments 136, 138, thereby further securing the interlocking connection, or dovetail joint 146, that adjoins the first and second wall segments 132, 134 of the sidewall 116a. Such spot welds can also be used in association with securing other components or accessories to the electrical box 100, including, for example, securing one or more mounting brackets to the electrical box 100.

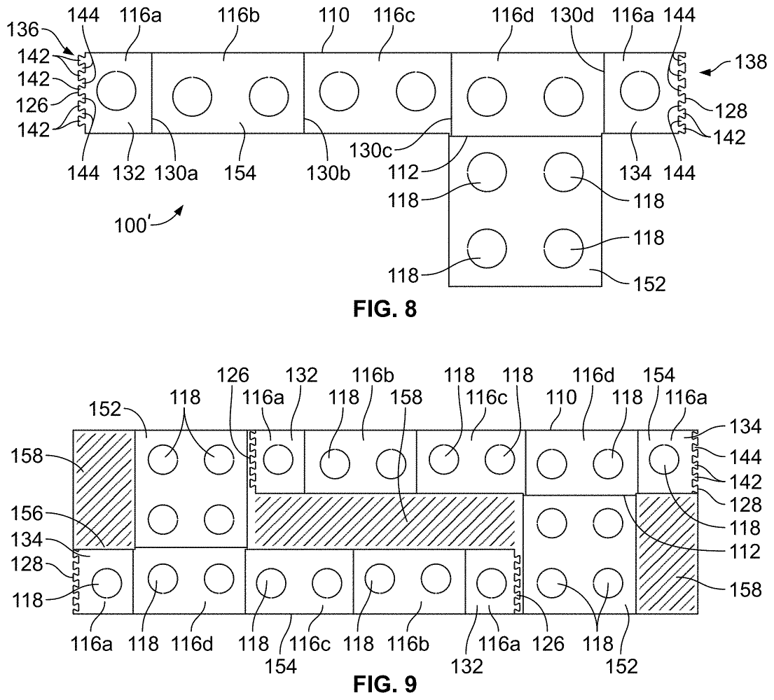

Alternatively, rather than adjoining a perimeter wall 102 to a separate back wall 104, according to other embodiments, the perimeter wall 102 and back wall 104 can be part of a unitary, monolithic body. For example, FIG. 8 illustrates a pre-formed electrical box 100′ having a back wall 152 that is adjoined to, and extends from, a mechanically closeable pre-formed perimeter wall 154 according to another embodiment of the present application. As seen, according to certain embodiments, the back wall 152 can be attached to, and extend, from, a portion of the edge 112 of the pre-formed perimeter wall 154. Aside from remaining part of the same sheet of material, and thus not being separated from each other, the pre-formed perimeter wall 154 and back wall 152 of the pre-formed electrical box 100′ shown in FIG. 8 can have features similar to those discussed above with respect to the pre-formed perimeter wall 124 and back wall 104 shown in at least FIGS. 2 and 3, respectively.

Thus, during construction, the pre-formed perimeter wall 154 shown in FIG. 8 can be bent in a manner that is generally similar to that discussed above with respect to the pre-formed perimeter wall 124 shown in at least FIGS. 2-5, and the joint segments 136, 138 of the pre-formed perimeter wall 154 can being matingly interlocked while the pre-formed perimeter wall 154, or resulting formed perimeter wall 102, remains adjoined to the back wall 104. Prior to, during, or upon formation of the sleeve configuration of the perimeter wall 102 using the pre-formed perimeter wall 154 shown in FIG. 8, the perimeter wall 102 or pre-formed perimeter wall 154 and/or the back wall 152 can be bent such that the back wall 152 is positioned at a location that is generally adjacent to each sidewall 116a-d, and thus, when the formation of the electrical box 100 is complete, at a positon that opposes the open end 108 of the electrical box 100. Such bending can result in the formation of a curved or rounded safe-touch corner between the back wall 152 and a sidewall 116d. One or more of the sidewalls 116a-c that are not attached to the back wall 152 can then be adjoined to the back wall 152, such as, for example, via a spot weld. Additionally, or optionally, one or more spot welds may also be used to further secure the locking engagement between the joint segments 136, 138.

FIG. 9 illustrates an exemplary pattern in connection with producing a plurality of the pre-formed electrical boxes 100′ shown in FIG. 8 from a single sheet of material 156. Cross hatched areas in FIG. 9 indicate areas of potential scrap material 158 in the sheet of material 156 that may not be utilized in producing the pre-formed electrical boxes 100′. As seen, and compared to traditional designs, the amount of potential scrap material 158 from the nesting of the pre-formed electrical boxes 101′ may be relatively low. The degree of potential scrap material 158 can also be lower for electrical boxes 100 having different shapes and sizes. For example, FIG. 10 illustrates a unitary pre-formed electrical box 100″ having a configuration that is similar to that shown in FIG. 8, but in which the distance between the upper and lower edges 110, 112 of the perimeter wall 160 of the pre-formed electrical box 100″ is larger than the corresponding distance for the perimeter wall 154 shown in FIG. 8. Thus, the pre-formed electrical box 100″ shown in FIG. 10 can provide an electrical box 100 having a larger box depth than the electrical box 100 that can be formed using the pre-formed electrical box 100′ shown in FIG. 8. As seen by a comparison of at least the size of the regions of scrap material 158, 162 from the sheets of material 156, 164 shown in FIGS. 9 and 11, the larger configuration provided by inclusion of the larger perimeter wall 160 shown in FIG. 10 can, in comparison to the unitary pre-formed electrical boxes 100′ shown in FIG. 9, result in a further reduction in the amount of potential scrap material 162.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

1. An electrical box comprising:
a perimeter wall having a plurality of sidewalls, each sidewall being orthogonal to an adjacent sidewall, and wherein adjacent sidewalls of the plurality of sidewalls are directly adjoined by a rounded corner, a first end of the perimeter wall being mechanically interlocked with a second end of the perimeter wall such that the first and second ends are coplanar; and
a base wall adjoined to the perimeter wall, the base wall and the perimeter wall defining an inner region of the electrical box.

2. The electrical box of claim 1, wherein the first end of the perimeter wall includes at least one pin, and wherein the second end of the perimeter wall includes at least one groove that is configured to matingly receive insertion of the at least one pin.

3. The electrical box of claim 1, wherein the first end of the perimeter wall includes a first plurality of pins and a first plurality of grooves, and wherein the second end of the perimeter wall includes a second plurality of pins and a second plurality of grooves, the first plurality of pins configured to be matingly received in the second plurality of grooves, and the second plurality of pins configured to be matingly received in the first plurality of grooves.

4. The electrical box of claim 3, wherein the first plurality of pins matingly interlock with the second plurality of grooves, and the second plurality of pins matingly interlock with the first plurality of grooves to mechanically interlock the first and second ends of the perimeter wall by a dovetail joint.

5. The electrical box of claim 4, wherein the dovetail joint extends along one sidewall of the plurality of sidewalls.

6. The electrical box of claim 5, wherein the electrical box further comprises a plurality of knockouts along at least one of the perimeter wall and the base wall.

7. The electrical box of claim 1, wherein the base wall and the perimeter wall form a monolithic structure, the base wall being connection to one of the plurality of sidewalls by a rounded corner.

8. The electrical box of claim 1, wherein the electrical box comprises a metallic material.

9. An electrical box comprising:
a plurality of sidewalls, one or more sidewalls of the plurality of sidewalls being directly adjoined to an adjacent, and orthogonally directed, sidewall of the plurality of sidewalls that by a rounded corner, and wherein at least one sidewall of the plurality of sidewalls comprising a first wall segment and a second wall segment, the first wall segment having one or more first joint segments that are at least mechanically interlocked with one or more second joint segments of the second wall segment such that the first wall segment is coplanar with the second wall segment; and
a base wall adjoined to the plurality of sidewalls, wherein the plurality of sidewalls and the base wall define an inner region of the electrical box.

10. The electrical box of claim 9, wherein the one or more first joint segments comprises at least one pin, and the one or more second joint segments comprises at least one groove, the at least one groove being configured to receive interlocking insertion of the at least one pin.

11. The electrical box of claim 10, wherein the one or more first joint segments and the one or more second joint segments are mechanically interlocked by a dovetail joint.

12. The electrical box of claim 9, wherein the base wall and the plurality of sidewalls are part of a monolithic structure, and wherein the base wall is adjoined to the plurality of sidewalls by a rounded corner.

13. The electrical box of claim 9, wherein the electrical box is constructed from a metallic material.

14. The electrical box of claim 9, wherein at least one of the plurality of sidewalls and the base wall includes one or more knockouts.

15. A method for forming an electrical box comprising:
bending a pre-formed perimeter wall along a plurality of boundary lines to form a plurality of sidewalls, at least one sidewall being orthogonal, and directly adjoined by a rounded corner, to another sidewall;
mechanically interlocking a first wall segment of a first sidewall of the plurality of sidewalls with a second wall segment of the first sidewall, the mechanically interlocked first and second wall segments being coplanar, and wherein the mechanically interlocked first and second wall segments and the plurality of sidewalls form a perimeter wall having a sleeve configuration; and
securing a base wall to one or more of the plurality of sidewalls, the secured base wall and the perimeter wall defining a inner region of the electrical box.

16. The method of claim 15, wherein securing the base wall comprises spot welding the base wall to one or more of the plurality of sidewalls.

17. The method of claim 16, further comprising bending the base wall about a lower edge of either the pre-formed perimeter wall or one of the plurality of sidewalls to a position at which the base wall can be secured to another sidewall of the plurality of sidewalls.

18. The method of claim 16, further including spot welding the first wall segment to the second wall segment.

19. The method of claim 16, wherein mechanically interlocking the first wall segment and the second wall segment comprises securing the first wall segment to the second wall segment by a dovetail joint.

20. The method of claim 16, further comprising forming a pre-formed electrical box, wherein the pre-formed electrical box comprises the pre-formed perimeter wall and the base wall, the base wall extending from a portion of a lower edge of the pre-formed perimeter wall.
